(19) United States
(12) Patent Application Publication
(10) Pub. No.: US 2013/0031458 A1
(43) Pub. Date: Jan. 31, 2013

(54) HYPERLOCAL CONTENT DETERMINATION

(71) Applicants: Akshay Java, Kirkland, WA (US); Amir Padovitz, Redmond, WA (US); Matthew Hurst, Seattle, WA (US); Sarah Zhai, Redmond, WA (US)

(72) Inventors: Akshay Java, Kirkland, WA (US); Amir Padovitz, Redmond, WA (US); Matthew Hurst, Seattle, WA (US); Sarah Zhai, Redmond, WA (US)

(73) Assignee: MICROSOFT CORPORATION, Redmond, WA (US)

(21) Appl. No.: 13/191,445

(22) Filed: Jul. 27, 2011

(51) Int. Cl. G06F 17/00

(52) U.S. Cl. 715/234

(57) ABSTRACT

First indicators may be obtained, each first indicator associated with a respective first web page document. A classification type of each first web page document may be determined, based on the respective first indicators and a respective first content of each first web page document. A set of candidate documents that are included in the first web page documents may be selected, based on the determined classification type. For each one of the candidate documents, a group of first attention geography items and a group of first content geography items associated with the each one of the candidate documents may be determined. A determination may be made whether each of the candidate documents includes a first hyperlocal content page document, based on the group of first attention geography items and the group of first content geography items that are associated with the candidate documents.

### BACKGROUND

Users of electronic devices are increasingly relying on information obtained from web pages as sources of news reports, ratings, descriptions of items, announcements, event information, and other various types of information that may be of interest to the users. Web pages may offer information on a broad range of topics, for example, ranging from simple descriptions of various items, to catalogs of information, to blogs that may cover opinions or discussions of various types of topics, to pages covering various types of events, and many other items.

Users may desire quick access to many types of documents as the user browses various web pages for particular types of information. For example, the user may desire current information associated with a particular geographic locale, such as their home neighborhood locale, or a geographic locale associated with a place they may wish to visit or research.

### SUMMARY

According to one general aspect, a system may include a reference acquisition component that obtains a first indicator associated with a first web page document. The system may also include a classification type component that determines a classification type of the first web page document, based on the first indicator and a first content of the first web page document. The system may also include an attention geography component that determines a group of first attention geography items associated with the first web page document. The system may also include a content geography component that determines a group of first content geography items associated with the first web page document, and a hyperlocal classifier that may determine whether the first web page document includes a first hyperlocal content page document, based on the group of the first attention geography items and the group of the first content geography items.

According to another aspect, a first indicator associated with a first web page document may be obtained. A plurality of second indicators may be determined, each second indicator associated with a device that is associated with a web visit of the first web page document. A plurality of first visitor geographic locations may be determined, each of the first visitor geographic locations associated with one of the second indicators, based on reverse geocoding the plurality of second indicators. A plurality of clusters of the first visitor geographic locations may be determined, based on distances between the first visitor geographic locations. A geographic locale focus associated with the first web page document may be determined, based on the plurality of clusters of the first visitor geographic locations.

According to another aspect, a computer program product tangibly embodied on a computer-readable storage medium may include executable code that may cause at least one data processing apparatus to obtain a plurality of first indicators, each first indicator associated with a respective one of a plurality of first web page documents. Further, the at least one data processing apparatus may determine a classification type of each of the first web page documents, based on the respective first indicators and a respective first content of each of the first web page documents. Further, the at least one data processing apparatus may select a set of candidate documents that are included in the plurality of first web page documents, based on the determined classification type. For each one of the candidate documents, the at least one data processing apparatus may determine a group of first attention geography items associated with the each one of the candidate documents, determine a group of first content geography items associated with the each one of the candidate documents, and determine whether the each one of the candidate documents includes a first hyperlocal content page document, based on the group of the first attention geography items and the group of the first content geography items that are associated with the each one of the candidate documents.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. The details of one or more implementations are set forth in the accompanying drawings and the description below. Other features will be apparent from the description and drawings, and from the claims.

### DRAWINGS

FIG. 1 is a block diagram of an example system for hyperlocal content determination.

FIG. 2 is a flowchart illustrating example operations of the system of FIG. 1.

FIG. 3 is a flowchart illustrating example operations of the system of FIG. 1.

FIG. 4 is a flowchart illustrating example operations of the system of FIG. 1.

FIG. 5 is a block diagram of an example system for hyperlocal content determination.

FIG. 6 depicts a curve that illustrates example access patterns.

FIG. 7 depicts a curve that illustrates example access patterns.

FIG. 8 depicts an example of a ranked ordering of URLs.

FIG. 9 is a bar graph illustrating entropy values over multiple web page documents.

FIG. 10 depicts an example ordering of blogs.

FIG. 11 is a curve illustrating points representing sets of localities.

FIG. 12 depicts an example result of entropy/information gain/loss determinations.

### DETAILED DESCRIPTION

Web pages are increasingly being used as sources of information for users of electronic devices. Thus, web pages may include information from a vast variety of sources, covering a vast variety of types of information. Users have many different desires as they initiate requests for information. For example, a user may wish to obtain information for research purposes, or for entertainment, schedule, or trip planning Many requests/searches may be based on geographic topics, which may range from universal questions to national questions, to hyperlocal questions. For example, a user may wish to obtain information regarding his/her residential neighborhood (e.g., traffic jams during rush hour drive home, movie, sports or music events for current evening entertainment).

Example techniques discussed herein may provide information regarding web page documents that include hyperlocal content. In this context, “hyperlocal content” may refer to information that pertains to entities, events, businesses and points of interests that may be relevant to a particular geographic area/location or locale. For example, a provider of the hyperlocal content may intend that the content is provided for consumption by residents of that area. According to an example embodiment, the hyperlocal content may be generated by residents of that area; however, hyperlocal content may also be provided by other sources.

Example hyperlocal discovery techniques discussed herein may include systems for identifying, discovering, and/or classifying sources of hyperlocal content, as discussed further below. According to an example embodiment, a hyperlocal content discovery system may include one or more blog discovery techniques, one or more attention geography analysis techniques, one or more blog crawlers, one or more content geography analysis techniques, and/or one or more hyperlocal classifier techniques, as discussed further below.

For example, a blog discovery technique may crawl the Web to discover blogs. For example, an attention geography analysis technique may mine web browser logs to determine whether a particular web page document (i.e., a documents associated with a Uniform Resource Locator (URL)) may be associated with a location bias, based on visitation patterns (e.g., patterns determined from an attention geography analysis technique).

For example, a content geography analysis technique may process content of the blogs to identify geo-locatable entities (e.g., partial addresses, businesses, points of interest, cities, counties, states, countries, neighborhoods). For example, a hyperlocal classifier technique may process a set of features that may be obtained via the content geography analysis, to determine whether the source provides hyperlocal content, as discussed further below. According to an example embodiment, the features may be used to determine whether the source is a hyperlocal blog.

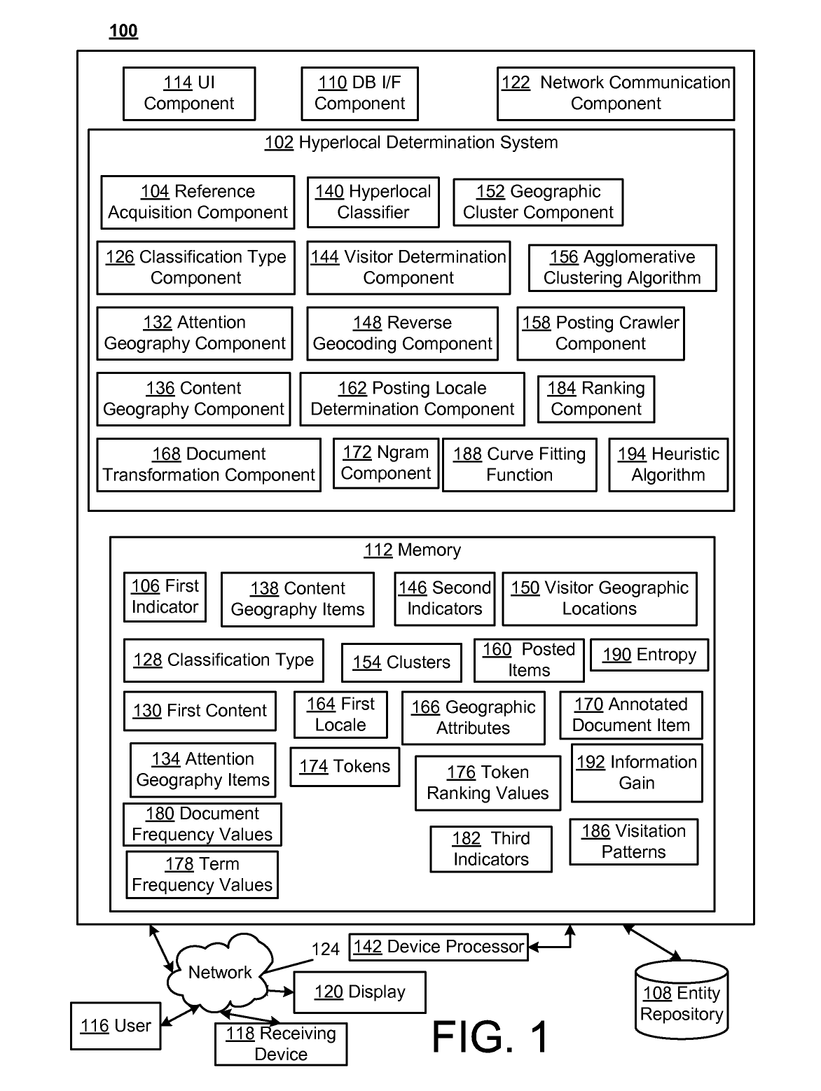

As further discussed herein, FIG. 1 is a block diagram of a system 100 for hyperlocal content determination. As shown in FIG. 1, a system 100 may include a hyperlocal determination system 102 that includes a reference acquisition component 104 that may obtain a first indicator 106 associated with a first web page document. For example, the first indicator 106 may include a seed URL provided by system management personnel.

According to an example embodiment, the hyperlocal determination system 102 may include executable instructions that may be stored on a computer-readable storage medium, as discussed below. According to an example embodiment, the computer-readable storage medium may include any number of storage devices, and any number of storage media types, including distributed devices.

For example, an entity repository 108 may include a one or more databases, and may be accessed via a database interface component 110. One skilled in the art of data processing will appreciate that there are many techniques for storing repository information discussed herein, such as various types of database configurations (e.g., SQL SERVERS) and non-database configurations.

According to an example embodiment, the hyperlocal determination system 102 may include a memory 112 that may store the first indicator 106. In this context, a “memory” may include a single memory device or multiple memory devices configured to store data and/or instructions. Further, the memory 112 may span multiple distributed storage devices.

According to an example embodiment, a user interface component 114 may manage communications between a user 116 and the hyperlocal determination system 102. The user 116 may be associated with a receiving device 118 that may be associated with a display 120 and other input/output devices. For example, the display 120 may be configured to communicate with the receiving device 118, via internal device bus communications, or via at least one network connection.

According to an example embodiment, the hyperlocal determination system 102 may include a network communication component 122 that may manage network communication between the hyperlocal determination system 102 and other entities that may communicate with the hyperlocal determination system 102 via at least one network 124. For example, the at least one network 124 may include at least one of the Internet, at least one wireless network, or at least one wired network. For example, the at least one network 124 may include a cellular network, a radio network, or any type of network that may support transmission of data for the hyperlocal determination system 102. For example, the network communication component 122 may manage network communications between the hyperlocal determination system 102 and the receiving device 118. For example, the network communication component 122 may manage network communication between the user interface component 114 and the receiving device 118.

A classification type component 126 may determine a classification type 128 of the first web page document, based on the first indicator 106 and a first content 130 of the first web page document. For example, a classification type may include a blog type, a sports type, or an events type.

An attention geography component 132 may determine a group of first attention geography items 134 associated with the first web page document, as discussed further below. A content geography component 136 may determine a group of first content geography items 138 associated with the first web page document, as discussed further below.

A hyperlocal classifier 140 may determine, via a device processor 142, whether the first web page document includes a first hyperlocal content page document, based on the group of the first attention geography items and the group of the first content geography items.

In this context, a “processor” may include a single processor or multiple processors configured to process instructions associated with a processing system. A processor may thus include multiple processors processing instructions in parallel and/or in a distributed manner. Although the device processor 142 is depicted as external to the hyperlocal determination system 102 in FIG. 1, one skilled in the art of data processing will appreciate that the device processor 142 may be implemented as a single component, and/or as distributed units which may be located internally or externally to the hyperlocal determination system 102, and/or any of its elements.

According to an example embodiment, the first indicator 106 associated with the first web page document may include a first Uniform Resource Locator (URL) associated with the first web page document. According to an example embodiment, the classification type 128 may include one or more of a blog web page type, a sports web page type, a local news web page type, or an event web page type.

According to an example embodiment, a visitor determination component 144 may determine a plurality of second indicators 146, each second indicator 146 associated with a device that is associated with a web visit of the first web page document.

According to an example embodiment, a reverse geocoding component 148 may determine a plurality of first visitor geographic locations 150, each of the first visitor geographic locations 150 associated with one of the second indicators 146.

According to an example embodiment, a geographic cluster component 152 may determine a plurality of clusters 154 of the first visitor geographic locations 150, based on distances between the first visitor geographic locations 150.

According to an example embodiment, the visitor determination component 144 may determine the plurality of second indicators 146, each second indicator 146 including one or more of an Internet Protocol (IP) address, Global Positioning System (GPS) coordinate information, or browser log information that is associated with a device that is associated with a web visit of the first web page document.

According to an example embodiment, the reverse geocoding component 148 may determine the plurality of first visitor geographic locations 150, each of the first visitor geographic locations 150 based on one or more of latitude and longitude values associated with one of the second indicators 146, visitor device location information associated with one of the second indicators 146, IP address information associated with one of the second indicators 146, or GPS coordinate information associated with one of the second indicators 146.

According to an example embodiment, the geographic cluster component 152 may determine the plurality of clusters 154 of the first visitor geographic locations 150, based on distances between the first visitor geographic locations 150, based on one or more of a k-means clustering algorithm or an agglomerative clustering algorithm 156.

According to an example embodiment, a posting crawler component 158 may obtain a plurality of first posted items 160 associated with the first web page document, based on initiating a plurality of first web page retrieval visits to the first web page document.

According to an example embodiment, a posting locale determination component 162 may determine a first locale 164 associated with the plurality of first posted items based on geographic attributes 166 associated with the obtained plurality of first posted items 160 associated with the first web page document.

In this context, a “locale” may include a geographic location and an area surrounding the location, or associated with the location. For example, a locale may include a geographic area that may be determined as relevant to an entity (e.g., a landmark, a city, a neighborhood, a person, an event). For example, a locale may include a geographic area within a predetermined distance of a geographic location, or within a predetermined bounded geographic area, or bounding or overlapping with a predetermined bounded geographic area.

According to an example embodiment, a document transformation component 168 may update a first annotated document item 170 associated with the first web page document via annotations based on the obtained plurality of first posted items 160 associated with the first web page document.

According to an example embodiment, an ngram component 172 may obtain tokens 174 based on text included in the plurality of first posted items 160 associated with the first web page document, and may determine ranking values 176 of obtained tokens 174 based on term frequency values 178 and document frequency values 180.

According to an example embodiment, the reference acquisition component 104 may obtain a plurality of third indicators 182 associated with a plurality of respective second web page documents. According to an example embodiment, a ranking component may rank the first web page document and second web page documents based on visitation patterns associated with each of the first web page document and second web page documents.

According to an example embodiment, the ranking component 184 may rank the first web page document and second web page documents based on visitation patterns 186 associated with each of the first web page document and second web page documents, based on one or more of a curve fitting function 188, a determination of entropy 190 and information gain 192, or a heuristic algorithm 194 based on clusters 154 determined by the attention geography component 132.

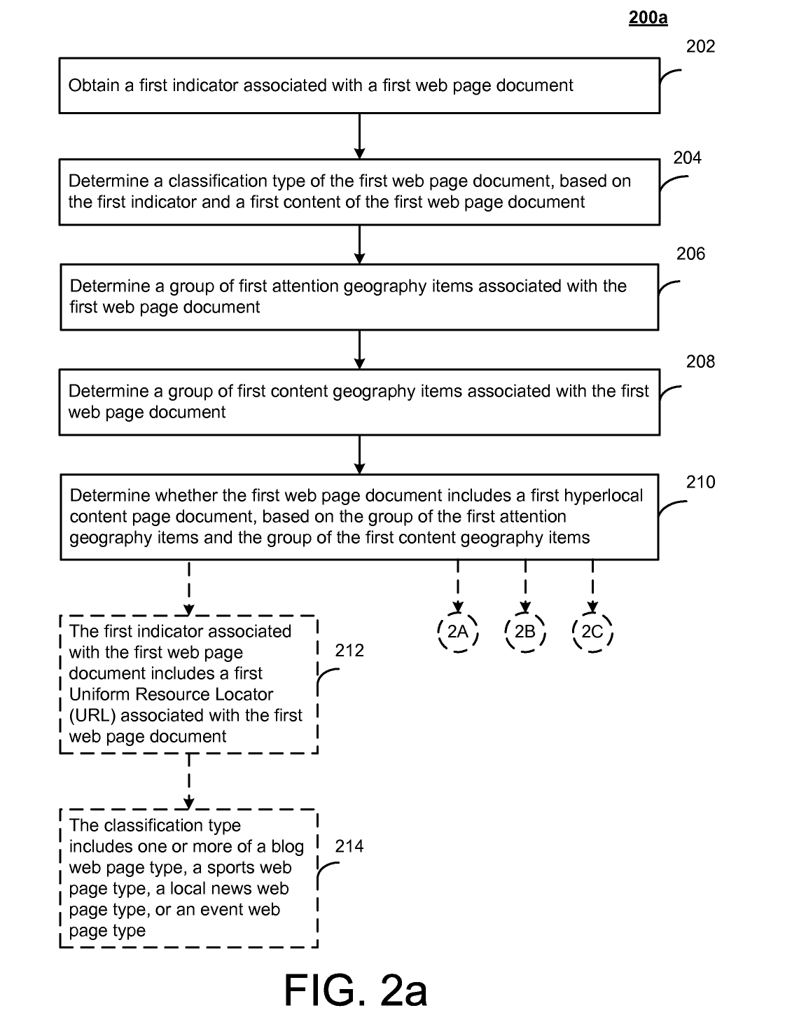

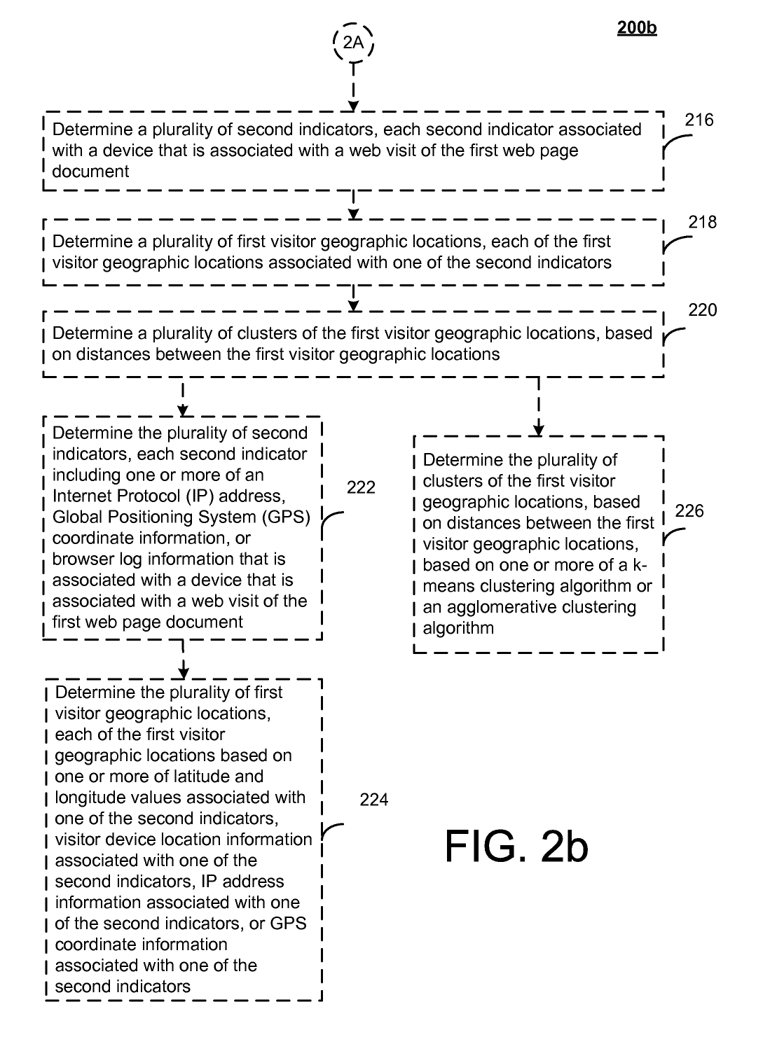

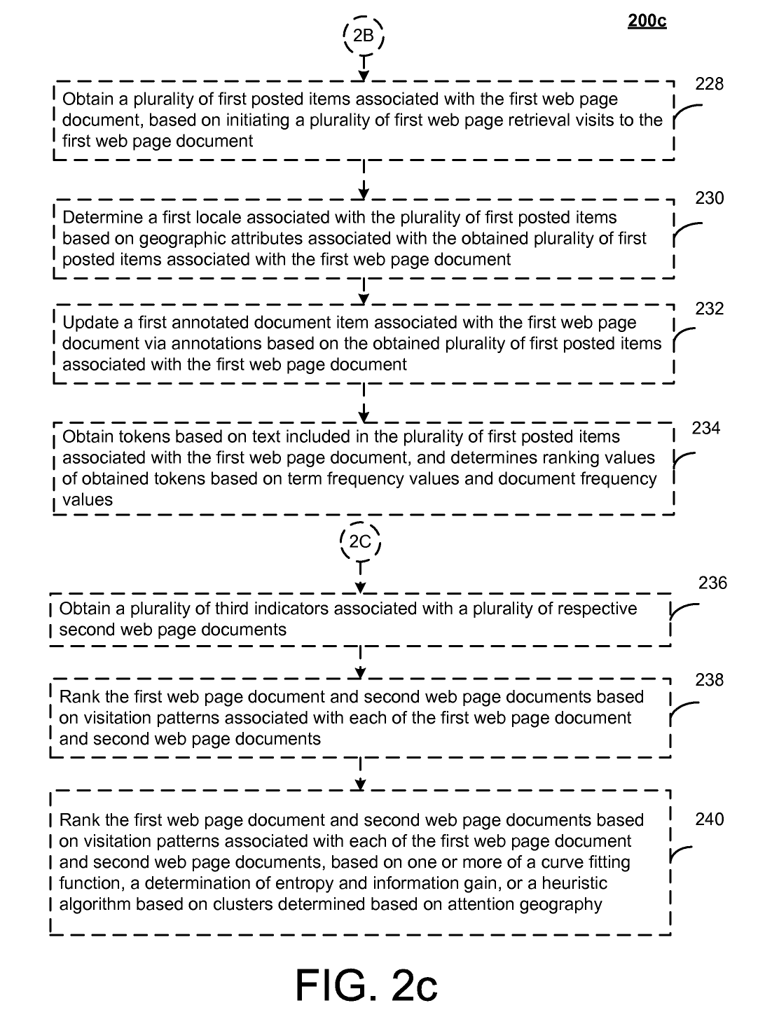

FIG. 2 is a flowchart illustrating example operations of the system of FIG. 1, according to example embodiments. In the example of FIG. 2a, a first indicator associated with a first web page document may be obtained (202). For example, the reference acquisition component 104 may obtain a first indicator 106 associated with a first web page document, as discussed above.

A classification type of the first web page document may be determined, based on the first indicator and a first content of the first web page document (204). For example, the classification type component 126 may determine a classification type 128 of the first web page document, based on the first indicator 106 and a first content 130 of the first web page document, as discussed above.

A group of first attention geography items associated with the first web page document may be determined (206). For example, the attention geography component 132 may determine a group of first attention geography items 134 associated with the first web page document, as discussed above.

A group of first content geography items associated with the first web page document may be determined (208). For example, the content geography component 136 may determine a group of first content geography items 138 associated with the first web page document, as discussed above.

It may be determined, via a device processor, whether the first web page document includes a first hyperlocal content page document, based on the group of the first attention geography items and the group of the first content geography items (210). For example, the hyperlocal classifier 140 may determine, via a device processor 142, whether the first web page document includes a first hyperlocal content page document, based on the group of the first attention geography items and the group of the first content geography items, as discussed above.

According to an example embodiment, the first indicator 106 associated with the first web page document may include a first Uniform Resource Locator (URL) associated with the first web page document (212).

According to an example embodiment, the classification type 128 may include one or more of a blog web page type, a sports web page type, a local news web page type, or an event web page type (214).

According to an example embodiment, a plurality of second indicators may be determined, each second indicator associated with a device that is associated with a web visit of the first web page document (216). For example, the visitor determination component 144 may determine a plurality of second indicators 146, each second indicator 146 associated with a device that is associated with a web visit of the first web page document, as discussed above.

According to an example embodiment, a plurality of first visitor geographic locations may be determined, each of the first visitor geographic locations associated with one of the second indicators (218). For example, the reverse geocoding component 148 may determine a plurality of first visitor geographic locations 150, each of the first visitor geographic locations 150 associated with one of the second indicators 146, as discussed above.

According to an example embodiment, a plurality of clusters of the first visitor geographic locations may be determined, based on distances between the first visitor geographic locations (220). For example, the geographic cluster component 152 may determine a plurality of clusters 154 of the first visitor geographic locations 150, based on distances between the first visitor geographic locations 150, as discussed above.

According to an example embodiment, the plurality of second indicators may be determined, each second indicator including one or more of an Internet Protocol (IP) address, Global Positioning System (GPS) coordinate information, or browser log information that is associated with a device that is associated with a web visit of the first web page document (222). For example, the visitor determination component 144 may determine the plurality of second indicators 146, each second indicator 146 including one or more of an Internet Protocol (IP) address, Global Positioning System (GPS) coordinate information, or browser log information that is associated with a device that is associated with a web visit of the first web page document, as discussed above.

According to an example embodiment, the plurality of first visitor geographic locations may be determined, each of the first visitor geographic locations based on one or more of latitude and longitude values associated with one of the second indicators, visitor device location information associated with one of the second indicators, IP address information associated with one of the second indicators, or GPS coordinate information associated with one of the second indicators (224). For example, the reverse geocoding component 148 may determine the plurality of first visitor geographic locations 150, each of the first visitor geographic locations 150 based on one or more of latitude and longitude values associated with one of the second indicators 146, visitor device location information associated with one of the second indicators 146, IP address information associated with one of the second indicators 146, or GPS coordinate information associated with one of the second indicators 146, as discussed above.

According to an example embodiment, the plurality of clusters of the first visitor geographic locations may be determined, based on distances between the first visitor geographic locations, based on one or more of a k-means clustering algorithm or an agglomerative clustering algorithm (226). For example, the geographic cluster component 152 may determine the plurality of clusters 154 of the first visitor geographic locations 150, based on distances between the first visitor geographic locations 150, based on one or more of a k-means clustering algorithm or an agglomerative clustering algorithm 156, as discussed above.

According to an example embodiment, a plurality of first posted items associated with the first web page document may be obtained, based on initiating a plurality of first web page retrieval visits to the first web page document (228). For example, the posting crawler component 158 may obtain a plurality of first posted items 160 associated with the first web page document, based on initiating a plurality of first web page retrieval visits to the first web page document, as discussed above.

According to an example embodiment, a first locale associated with the plurality of first posted items may be determined based on geographic attributes associated with the obtained plurality of first posted items associated with the first web page document (230). For example, the posting locale determination component 162 may determine a first locale 164 associated with the plurality of first posted items based on geographic attributes 166 associated with the obtained plurality of first posted items 160 associated with the first web page document, as discussed above.

According to an example embodiment, a first annotated document item associated with the first web page document may be updated via annotations based on the obtained plurality of first posted items associated with the first web page document (232). For example, the document transformation component 168 may update a first annotated document item 170 associated with the first web page document via annotations based on the obtained plurality of first posted items 160 associated with the first web page document, as discussed above.

According to an example embodiment, tokens may be obtained based on text included in the plurality of first posted items associated with the first web page document, and determines ranking values of obtained tokens based on term frequency values and document frequency values (234). For example, the ngram component 172 may obtain tokens 174 based on text included in the plurality of first posted items 160 associated with the first web page document, and may determine ranking values 176 of obtained tokens 174 based on term frequency values 178 and document frequency values 180, as discussed above.

According to an example embodiment, a plurality of third indicators associated with a plurality of respective second web page documents may be obtained (236). For example, the reference acquisition component 104 may obtain a plurality of third indicators 182 associated with a plurality of respective second web page documents, as discussed above.

According to an example embodiment, the first web page document and second web page documents may be ranked based on visitation patterns associated with each of the first web page document and second web page documents (238). For example, the ranking component may rank the first web page document and second web page documents based on visitation patterns associated with each of the first web page document and second web page documents, as discussed above.

According to an example embodiment, the first web page document and second web page documents may be ranked based on visitation patterns associated with each of the first web page document and second web page documents, based on one or more of a curve fitting function, a determination of entropy and information gain, or a heuristic algorithm based on clusters determined based on attention geography (240). For example, the ranking component 184 may rank the first web page document and second web page documents based on visitation patterns 186 associated with each of the first web page document and second web page documents, based on one or more of a curve fitting function 188, a determination of entropy 190 and information gain 192, or a heuristic algorithm 194 based on clusters 154 determined by the attention geography component 132, as discussed above.

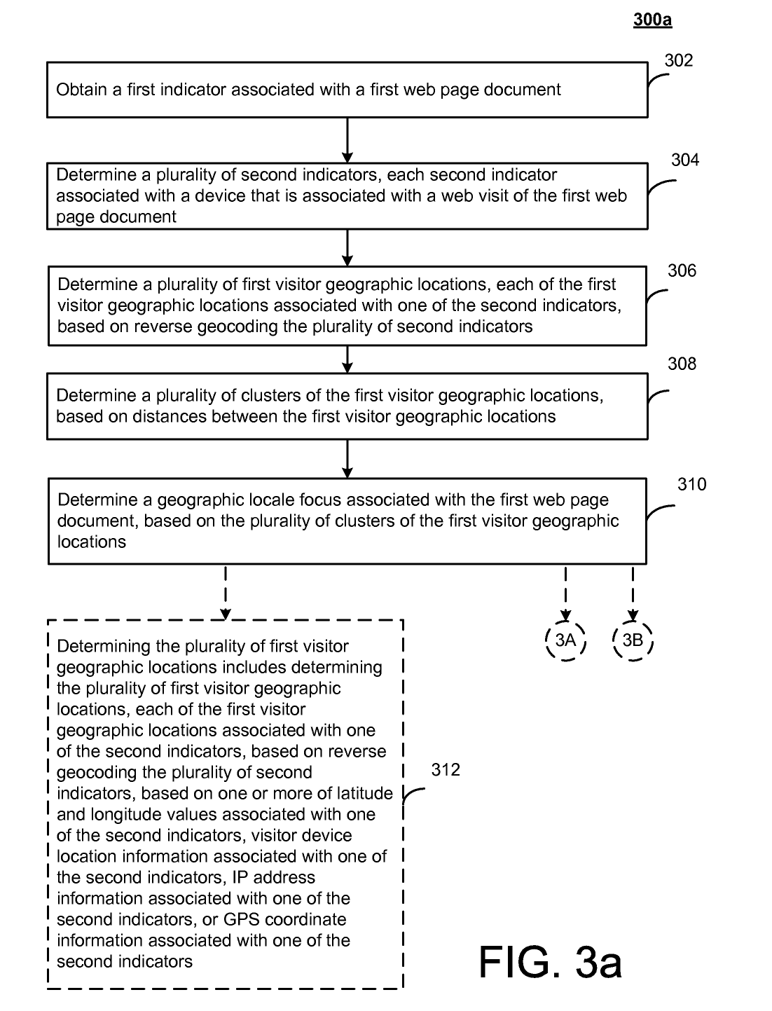

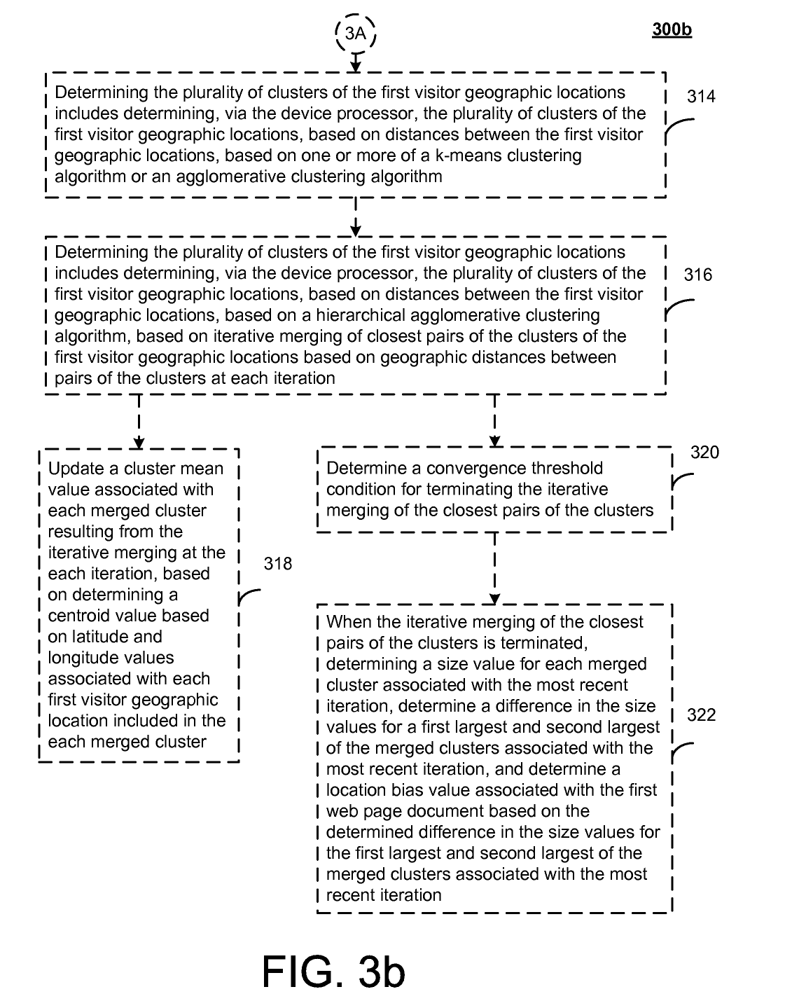

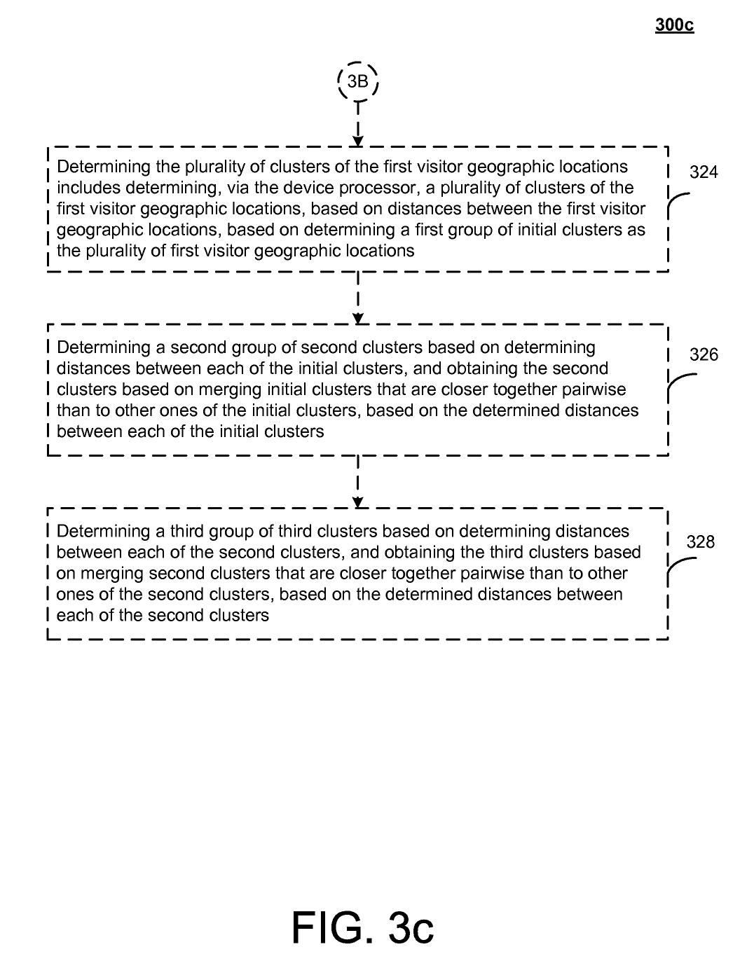

FIG. 3 is a flowchart illustrating example operations of the system of FIG. 1, according to example embodiments. In the example of FIG. 3a, a first indicator associated with a first web page document may be obtained (302). For example, the reference acquisition component 104 may obtain a first indicator 106 associated with a first web page document, as discussed above.

A plurality of second indicators may be determined, each second indicator associated with a device that is associated with a web visit of the first web page document (304). A plurality of first visitor geographic locations may be determined, each of the first visitor geographic locations associated with one of the second indicators, based on reverse geocoding the plurality of second indicators (306).

A plurality of clusters of the first visitor geographic locations may be determined, based on distances between the first visitor geographic locations (308). A geographic locale focus associated with the first web page document may be determined, based on the plurality of clusters of the first visitor geographic locations (310).

According to an example embodiment, determining the plurality of first visitor geographic locations may include determining the plurality of first visitor geographic locations, each of the first visitor geographic locations associated with one of the second indicators, based on reverse geocoding the plurality of second indicators, based on one or more of latitude and longitude values associated with one of the second indicators, visitor device location information associated with one of the second indicators, IP address information associated with one of the second indicators, or GPS coordinate information associated with one of the second indicators (312).

According to an example embodiment, determining the plurality of clusters of the first visitor geographic locations may include determining the plurality of clusters of the first visitor geographic locations, based on distances between the first visitor geographic locations, based on one or more of a k-means clustering algorithm or an agglomerative clustering algorithm (314).

According to an example embodiment, determining the plurality of clusters of the first visitor geographic locations may include determining the plurality of clusters of the first visitor geographic locations, based on distances between the first visitor geographic locations, based on a hierarchical agglomerative clustering algorithm, based on iterative merging of closest pairs of the clusters of the first visitor geographic locations based on geographic distances between pairs of the clusters at each iteration (316).

According to an example embodiment, a cluster mean value associated with each merged cluster resulting from the iterative merging may be updated at the each iteration, based on determining a centroid value based on latitude and longitude values associated with each first visitor geographic location included in the each merged cluster (318).

According to an example embodiment, a convergence threshold condition for terminating the iterative merging of the closest pairs of the clusters may be determined (320). According to an example embodiment, when the iterative merging of the closest pairs of the clusters is terminated, a size value for each merged cluster associated with the most recent iteration may be determined, a difference in the size values for a first largest and second largest of the merged clusters associated with the most recent iteration may be determined, and a location bias value associated with the first web page document may be determined based on the determined difference in the size values for the first largest and second largest of the merged clusters associated with the most recent iteration (322).

According to an example embodiment, determining the plurality of clusters of the first visitor geographic locations may include determining, via the device processor, a plurality of clusters of the first visitor geographic locations, based on distances between the first visitor geographic locations, based on determining a first group of initial clusters as the plurality of first visitor geographic locations, determining a second group of second clusters based on determining distances between each of the initial clusters, and obtaining the second clusters based on merging initial clusters that are closer together pairwise than to other ones of the initial clusters, based on the determined distances between each of the initial clusters (326).

According to an example embodiment, a third group of third clusters may be determined based on determining distances between each of the second clusters, and obtaining the third clusters based on merging second clusters that are closer together pairwise than to other ones of the second clusters, based on the determined distances between each of the second clusters (328).

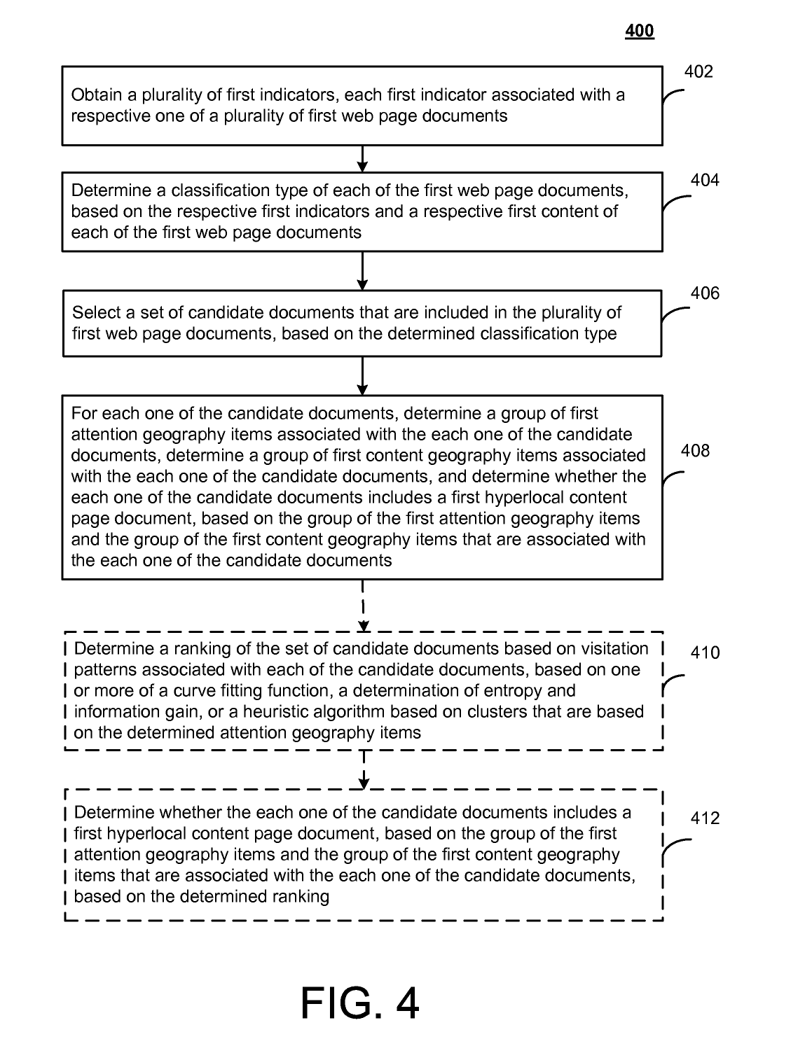

FIG. 4 is a flowchart illustrating example operations of the system of FIG. 1, according to example embodiments. In the example of FIG. 4a, a plurality of first indicators may be obtained, each first indicator associated with a respective one of a plurality of first web page documents (402).

A classification type of each of the first web page documents may be determined, based on the respective first indicators and a respective first content of each of the first web page documents (404). A set of candidate documents that are included in the plurality of first web page documents may be selected, based on the determined classification type (406). According to an example embodiment, for each one of the candidate documents, a group of first attention geography items associated with the each one of the candidate documents may be determined, a group of first content geography items associated with the each one of the candidate documents may be determined, and it may be determined whether the each one of the candidate documents includes a first hyperlocal content page document, based on the group of the first attention geography items and the group of the first content geography items that are associated with the each one of the candidate documents (408).

According to an example embodiment, a ranking of the set of candidate documents may be determined based on visitation patterns associated with each of the candidate documents, based on one or more of a curve fitting function, a determination of entropy and information gain, or a heuristic algorithm based on clusters that are based on the determined attention geography items (410).

According to an example embodiment, it may be determined whether the each one of the candidate documents includes a first hyperlocal content page document, based on the group of the first attention geography items and the group of the first content geography items that are associated with the each one of the candidate documents, based on the determined ranking (412).

As discussed above, hyperlocal content may include information that pertains to entities, events, businesses and points of interests that may be considered relevant to a particular geographic area/location. For example, the content may be intended for consumption by residents of that area. For example, the content may be created by residents of that location. However, the example techniques discussed herein are not limited to content intended for consumption by residents of that area, or to content created by residents of that location.

Example techniques discussed herein may automatically identify, discover and classify sources of hyperlocal content. According to an example embodiment, hyperlocal blogs maybe identified; the example techniques discussed herein may be used to identify any type of hyperlocal content.

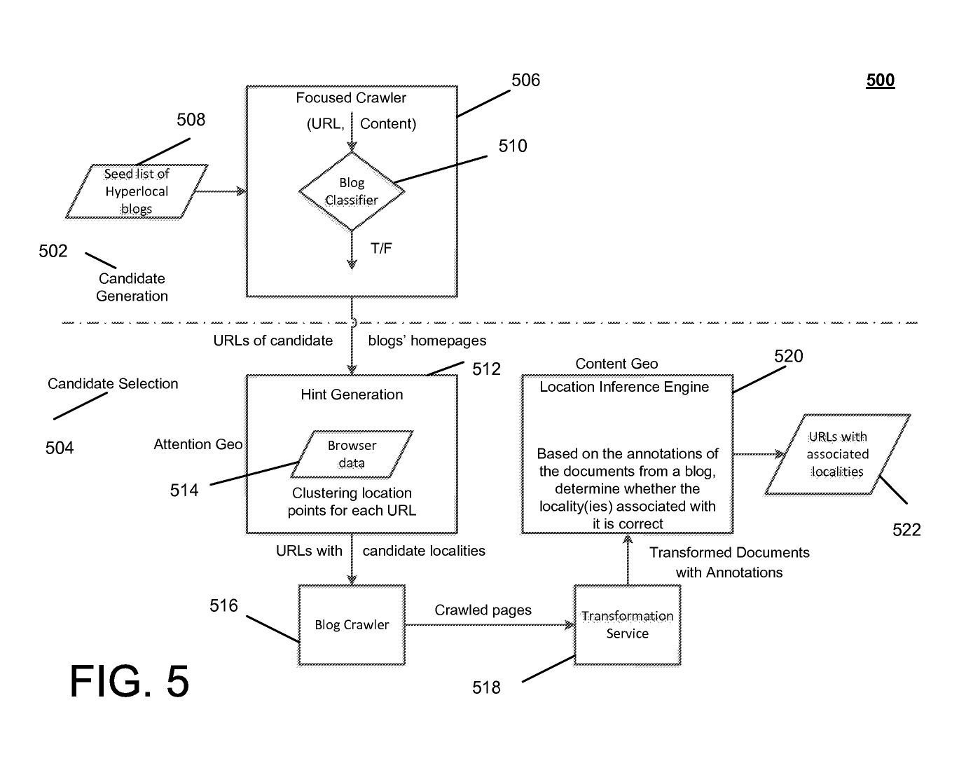

FIG. 5 is a block diagram of an example system 500 for hyperlocal content determination. As shown in FIG. 5, system 500 may include two stages, depicted as candidate generation 502 and candidate selection 504.

According to an example embodiment, candidate generation may be performed via a focused crawler 506. According to an example embodiment, the focused crawler 506 may obtain a list 508 of URLs of manually selected hyperlocal blogs (seeds), and may download web pages that are classified as blog pages. According to an example embodiment, a blog classifier 510 may determine the classification based on both the URL and the content of the page (i.e., the relevance of a page is determined after downloading its content). The pages that are classified as non-blog may be discarded. For the pages that are classified as blog, their URLs may be sent to the candidate selection 504 stage, and URLs included in the pages may be added to a crawl frontier. According to an example embodiment, a URL may be normalized to obtain its homepage URL, using one or more heuristics.

Thus, according to an example embodiment, a discovery technique may crawl the Web and classify content to determine if a web document (e.g., based on a URL) includes a blog or some other type of webpage. According to an example embodiment, web documents discovered by the discovery technique may be processed to determine attention geography features. According to an example embodiment, attention geography items may be determined based on mining for visitation patterns from sources such as web browser logs.

According to an example embodiment, the candidate selection 504 stage may include a series of components that filter the candidates based on example hyperlocal source concepts. For example, a hyperlocal source concept may determine sources that publish mostly content on local topics (e.g., entities, events, policies, persons in the area of interest) with local intent (e.g., the intended audience is within a particular area/location). According to an example embodiment, local intent may be determined by determining the attention geography 512 of a candidate blog, based on mining historical web browser logs 514. One skilled in the art of data processing will understand that many other types of reverse geocoding techniques may also be used to determine locations from which a web page may be visited, without departing from the spirit of the discussion herein.

For each candidate URL, a set of points representing the geographic locations of the visits (attentions) may be obtained. According to an example embodiment, the visits may be geographically clustered to model concentrations of visits from a particular area. According to an example embodiment, blogs that are of local interest may be identified by measuring the difference between the proportion of visits between the first and the second cluster. Higher drop-offs may indicate a greater geographical bias. According to an example embodiment, the topmost cluster may be identified as the most significant cluster.

According to an example embodiment, the locations associated with the topmost cluster may be included as candidates for an expected city. The expected city may be identified by selecting the city with the highest visits. Additionally, one or more heuristics (e.g., determine whether a candidate city is mentioned in the title of the blog) may be used in selecting the expected city.

For example, if a bias is determined in visits from a location (or a set of locations) for a particular web page document (e.g., based on a URL), then an indicator associated with that web page document (e.g., a URL), along with the location prior may be added to a list of feeds that may be crawled on a scheduled basis.

According to an example embodiment, a next step in an example discovery technique may run a blog crawler 516. In order to decide whether or not the posts from a blog are mostly about local topics, posts from these blogs may be downloaded using the blog crawler 516 and geo-entities may be extracted from them, as discussed further below. In this context, a “blog crawler” may refer to a system that regularly fetches the Really Simple Syndication (RSS)/ATOM syndication format feed of a blog and adds it to an index. According to an example embodiment, the indexed blogs may undergo a transformation 518 in which various annotations may be added to a document (e.g., a weblog post). For example the annotations may include one or more mentions of implicit addresses, businesses, points of interest, cities, counties, states, etc. Each of these geographic entities may be grounded to their fully qualified address and latitude/longitude information by performing a geocoding operation, as discussed further below.

According to an example embodiment, a content geography 520 technique may further process the web page content. Once there are a sufficient number of posts for a given blog, a hyperlocal classifier may be used to determine whether the content is hyperlocal in nature.

According to an example embodiment, using the set of annotated documents from a blog analysis it may be verified whether the blog is hyperlocal, and an expected locality and granularity (i.e., if the blog is a STATE/CITY/COUNTY/NEIGHBORHOOD level blog) may be determined.

According to an example embodiment, address extraction (e.g., identifying and grounding implicit address references from blog text) may be performed as follows. First, full address extraction may be performed, in which every address is considered in isolation. Each inferred address is then re-examined, in the context of other inferred addresses.

An example technique for extracting the addresses in isolation may include three stages: candidate generation, signal acquisition and reasoning. During candidate generation address candidates may be conflated in text that may be generated by multiple techniques. For example, a natural language based classifier may be used for obtaining candidates by searching for language driven cues, and a pattern based lookup that leverages knowledge of the address domain. According to an example embodiment, an ensemble classifier may merge and resolve conflicting candidates. During this resolution candidates that have larger span in text and alternative resolutions are also retained.

For example, a candidate for the segment in text “Fourth St. and Fifth” may be generated, as well as candidates for “Fourth St.” and “Fifth”. According to an example embodiment, “Fourth St. and Fifth” may be retained as the main candidate for address mention, given that it has the largest span, but alternative interpretations may also be retained, in which there are two separate addresses rather than an intersection. This may be useful, for example, for the phrase “there are road blocks between Fourth St. and Fifth”, which may indicate an intention of referring to two separate roads rather than an intersection. According to an example embodiment, candidate generation may provide a unified set of address candidates together with possible alternative interpretations.

According to an example embodiment, a next stage may include context and signal acquisition, in which the technique may run one or more classifiers and extractors that produce context for grounding and reasoning of the candidates. According to an example embodiment, city extraction, neighborhood extraction, state and county extraction may be used. Generally, a blog may be associated with a metro area, and addresses expressed in its posts may be mainly associated with that metro area. At the end of this stage, different segments in the text are provided that may represent entities that are associated with a location, such as cities and neighborhoods.

According to an example embodiment, a next stage may include reasoning and grounding. According to an example embodiment, a geo-mapping technique may be used to determine whether a candidate exists in the real world. In generating a candidate for such verification, the context signals from the previous stage may be combined with the candidate of the partial address representation. For example, the city “San Diego” may have been extracted in the same paragraph of the candidate “Main Street”. Thus, “Main Street San Diego” may be included as a candidate for grounding.

According to an example embodiment, one or more signals may be combined with segments of the original candidates, the list may be ordered based on the strength of the context signal with which it is associated. For example, a mention of a city in the paragraph of the candidate may be stronger than a city mentioned elsewhere in text, etc. The ordered list of grounded candidates may then be tested against a mapping service.

Results from the mapping service testing may then be interpreted semantically to determine the result of mapping. Because mapping of candidate queries allows fuzziness and ambiguity it may respond with results that may be semantically different than those intended. For example, a query “Falser St. San Francisco” may be posed, and an address “Folsom Street San Francisco” may be received in response.

An understanding that two different places may be in question (i.e., the intended one is different than the mapping outcome) is considered a decision to accept or reject the mapping result. As another example, “Market Ave Seattle” may be posed as a query (as a result of user free-form input in text), resulting in a response “Market Street NE Seattle”. In the latter case it may be understood that the difference is in the road type—a user type error—and thus may refer to the same place. According to an example embodiment, an address semantic similarity technique may determine the nature of differences between the candidate address and the returned address by the mapping service. The document may be annotated with the inferred address together with positioning information produced by the mapping service such as the longitude and latitude.

At this point, the example technique provides references to grounded addresses in text. These entities may be considered as candidates or hypothesis again and the entire set of inferred addresses in the document may be considered in order to accept, reject or modify them. It may be desirable to determine combinations of address fragments which are meaningful together and which are incorrect in isolation, for example, address ranges. For example, a segment in text such as “Main Street between fourth and Fifth Ave.” may be identified in isolation as two addresses, e.g., “Main Street, Seattle” and “Fifth Avenue, Seattle” (e.g., “fourth” in lower case may refer to Fourth Avenue, which may not have been extracted). Each of the two extracted addresses with their associated positions may be incorrect, such that the correct positioning may include a range of addresses rather than two points arbitrarily chosen for the corresponding roads.

According to an example embodiment, language patterns associated with address ranges may be identified. A most likely set of expected addresses involved may be reasoned, and the set of potential candidates may be modified.

Language patterns may refer to techniques in which address ranges may be expressed in text. As a result, new candidates may be identified that may be missed in initial steps, and the new candidates may be fit and grounded, together with the original candidates, to the pattern. For example, “Main Street between fourth and Fifth Ave.” may include an address range. Thus, two pairs of addresses may be coupled and grounded (“Main Street and fourth, Seattle” and “Main Street and Fifth Ave. Seattle”). These pairs may then be mapped using the mapping service. The original annotations may be modified to denote the true range and appropriate positions, if the mapping service results are successful.

The hyperlocal blog classification system may be used to train a model to automatically classify hyperlocal blogs. According to an example embodiment, a machine learning algorithm may be used to generate a model derived from a set of training data. According to an example embodiment, the classification algorithm analyzes the content of the blog. According to an example embodiment, the training data may include a blog and a set of features extracted by the transformation 518 technique. Examples of extracted significant features may include textual ngram features, a number of distinct city mentions, a city entropy value, a number of posts having partial addresses mentions, a number of posts having neighborhood mentions, an average score for different topics for the blog, a number of posts that include a partial address in their title, and/or a number of posts that mention a county, as discussed further below.

For example, the text from the posts in a blog may be tokenized and transformed to a set of ngram features. In this context, “tokens” may refer to smallest atomic units (e.g., elements) of data. For example, a token may include a single word of a language, or a single character of an alphabet. For example, a token may include a phrase included in a corpus based on phrases, or a word in a corpus based on words.

In this context, an ngram may refer to a sequence of n sequential tokens. Each of the tokens may be scored based on a TF-DF value, which may be determined as a score value, in accordance with:

Score=(tf+0.5)*log (N/df) (1)

wherein
tf represents the term frequency (the number of times the term appears in the blog, across all posts in the blog),
df represents the document frequency (the number of documents in which the term appears in the collection), and
N represents the total number of documents in the collection.

The number of distinct city mentions refers to the total number of distinct city name mentions in the blog.

According to an example embodiment, the city entropy may be determined as the entropy measure on the distribution of aggregated city mentions identified from posts of the blog.

According to an example embodiment, an average score for different topics for the blog may be obtained by training another classifier that operates on a language model of the blog content and identifies an associated topic for each post. For example, the topics may include one or more of sports, food, police, events, news, crime, politics, etc.

According to an example embodiment, web browser logs may provide access to the browsing patterns of a large collection of users. According to an example embodiment, no personally identifiable information is used, as the data in aggregate may provide the information desired for hyperlocal content determinations. According to an example embodiment, a collection of URLs may be obtained for which location information is desired. According to an example embodiment, each visit to a URL may be identified, and the user's IP address associated with the visit may be reverse geocoded, thus providing location (e.g., latitude and longitude) information, potentially indicating where the user was at the time of the visit. These visits may be analyzed over a period of time to determine a distribution of the visits from various locations.

According to an example embodiment, a geographic clustering of the visits may be determined to group the visits from nearby locations. For example, the geographic clustering may aid in accounting for visits from metro areas and other adjoining locations around a city. According to an example embodiment, an agglomerative clustering algorithm may be used to perform the clustering. One skilled in the art of data processing will understand that many different clustering techniques may be used for determining the geographic clusters (e.g., a k-means clustering technique).

According to an example embodiment, each visit initially is determined as a cluster, and then the clusters may be grouped hierarchically. According to an example embodiment, two clusters that are geographically closer to each other may be merged to form a new cluster. According to an example embodiment, the cluster means may be updated as the centroid of the latitudes and longitudes in that cluster.

When the clustering algorithm converges, each URL may be associated with a number of clusters, each of which indicates a group of users (e.g., visitors to the URL) that is geographically closer to each other and that have visited the URL.

According to an example embodiment, after the clusters are obtained, a URL that indicates a large difference (e.g., a drop off) between the size of the largest cluster and the second largest cluster, may indicate a location bias associated with the URL. According to an example embodiment, the RSS/ATOM feeds for such URLs may then be provided to the blog crawler 516 to fetch and process their feeds periodically.

According to an example embodiment, several different heuristics may be used for identifying geographical bias and ranking the URLs based on how strongly they are associated with specific attention geography. For example, the URLs may be ranked based on visitation patterns, as discussed further below.

According to an example embodiment, a curve fitting technique may be based on an intuition that a blog that is hyperlocal in nature and has some location bias may be associated with a distinct distribution of URL visitations. According to an example embodiment, a function that approximates an example curve fitting distribution may be represented in accordance with Equation 2:

β*(1+distance)^{α} (2)

wherein β represents a constant and α represents a curve fitting parameter.

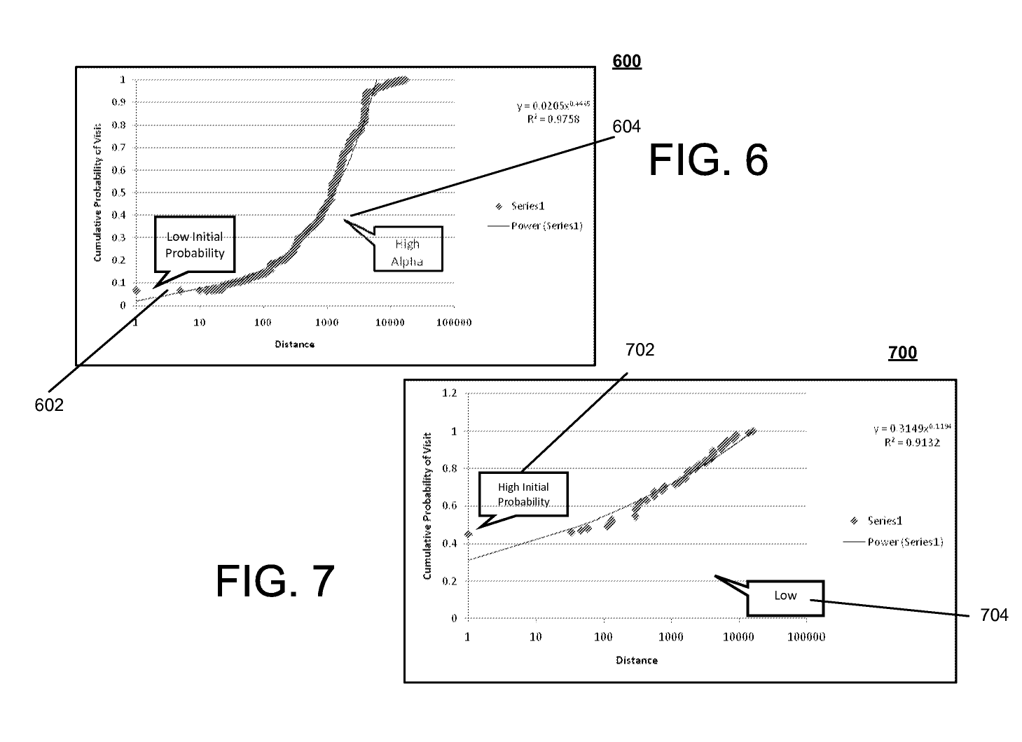

FIG. 6 depicts a curve 600 that illustrates example access patterns for a site that is not determined as including hyperlocal content. As shown in FIG. 6, the curve 600 indicates a low initial probability 602 and a high alpha 604.

FIG. 7 depicts a curve 700 that illustrates example access patterns for a site that is determined as including hyperlocal content. As shown in FIG. 7, the curve 700 indicates a high initial probability 702 and a low alpha 704.

Based on the intuition discussed above, the URL access patterns may be obtained and the blogs may be ranked based on their fit with the function shown above as Equation 2. According to an example embodiment, a conventional curve fitting algorithm may be used for curve fitting. According to an example embodiment, a low value of alpha may indicate that a blog may be associated with a location skew or bias.

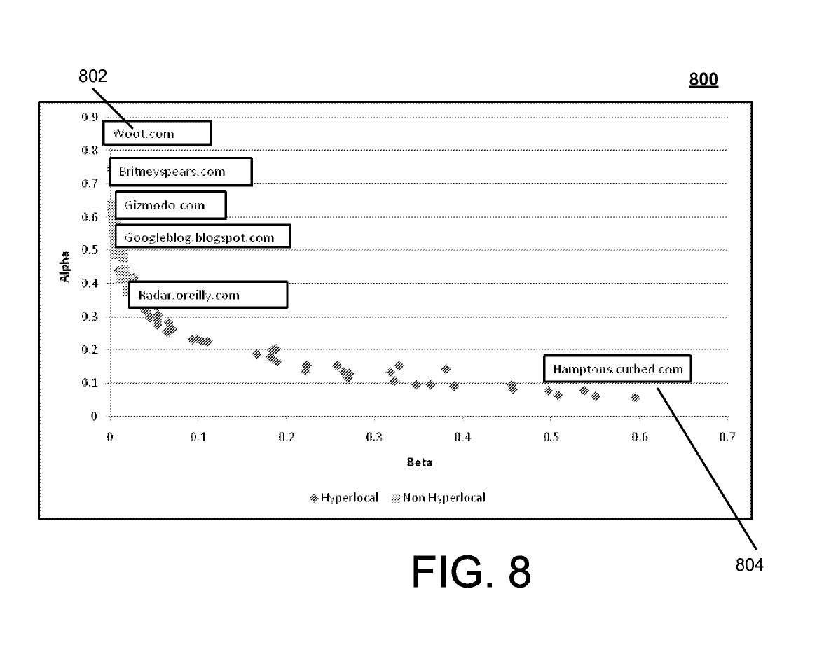

FIG. 8 depicts an example of a ranked ordering of non-hyperlocal URLs 802 and hyperlocal URLs 804 based on the ranking function discussed above. According to an example embodiment, a distribution of attention signals may be represented in accordance with an entropy-based function, in accordance with Equation 3:

Entropy(X)=Σᵢ₌₁ⁿp(xᵢ) log_{b}p(xᵢ) (3)

wherein the xᵢ represent the set of cities associated with inferred locations (the attention signals) associated with visiting users.

According to an example embodiment, a first step in the technique may determine a value of entropy over the set of cities associated with inferred locations (the attention signals) associated with visiting users.

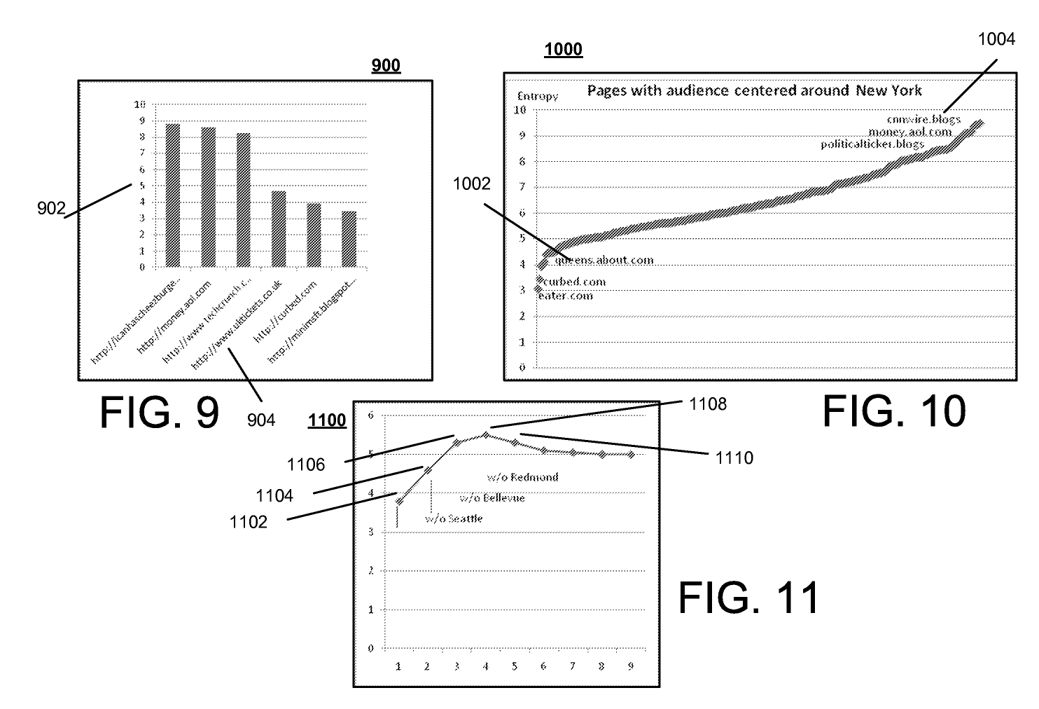

FIG. 9 is a bar graph 900 illustrating entropy values 902 over multiple web page documents 904. As shown in FIG. 9, hyperlocal blogs may be associated with lower attention location entropy than non-hyperlocal blogs. Thus, attention location entropy may be used to distinguish between hyperlocal and non-hyperlocal blogs.

FIG. 10 depicts an example ordering of blogs 1002, 1004. According to an example embodiment, the blogs may be ordered (ranked) based on their associated respective location visitation entropy values, as those blogs associated with lower location visitation entropy values (e.g., blogs 1002) may be determined as hyperlocal and those associated with higher location visitation entropy values (e.g., blogs 1004) may be determined as non-hyperlocal.

According to an example embodiment, information loss may be used to provide a greater separation between values used in determinations of hyperlocal vs. non-hyperlocal blogs. According to an example embodiment, cumulative information loss, as discussed below, may be used differentiate a more precise locality, other than at a single city level. According to an example embodiment, an example cumulative loss value may be determined in accordance with the example cumulative loss algorithm as shown in Algorithm 1 below.

Algorithm 1

// Example determination of cumulative information loss

| | |
|---|---|
| 1. | Set = complete set of visitation localities |
| 2. | Ent1 = entropy of Set |
| 3. | Ent2 = entropy of (Set - {city appearing most in Set}) |
| | // Remove the city appearing most in the set and recompute |

Entropy as Ent2

| | |
|---|---|
| 4. | GL = Ent1 − Ent2 |
| | // The gain/loss value GL is computed as the difference |

Ent1 − Ent2

| | |
|---|---|
| 5. | Repeat from step 3 until a single city location remains in Set |

According to an example embodiment, the sequence of gain/loss values (i.e., GL values) determined by Algorithm 1 may be used to obtain a more distinct locality range. For example, a blog that publishes local content may attract an audience from a main city, and may also attract an expanded audience from nearby towns or other cities in the vicinity of the main city.

By determining the change in entropy after removing a locality (e.g., a city) an increase in value may be expected if the city is part of the hyperlocal focus location and a decline in value may be expected if it is not.

FIG. 11 is a curve 1102 illustrating points representing sets of localities. According to an example embodiment, entropy over the complete set of visitation locations may be determined. As an example, Seattle (the location appearing most) may be removed from the set, and gain in value may be observed at point 1104. Bellevue (the location appearing second most) visitations may be removed next, and another gain in value may be observed at point 1106. Continuing, Redmond visitations may be removed (e.g., illustrated by point 1108), until a loss in value may be observed (e.g., illustrated by point 1110), which may indicate an end of clustering of nearby relevant localities.

According to an example embodiment, it may also be verified that locations being dropped are within a predetermined boundary distance from the previously dropped location.

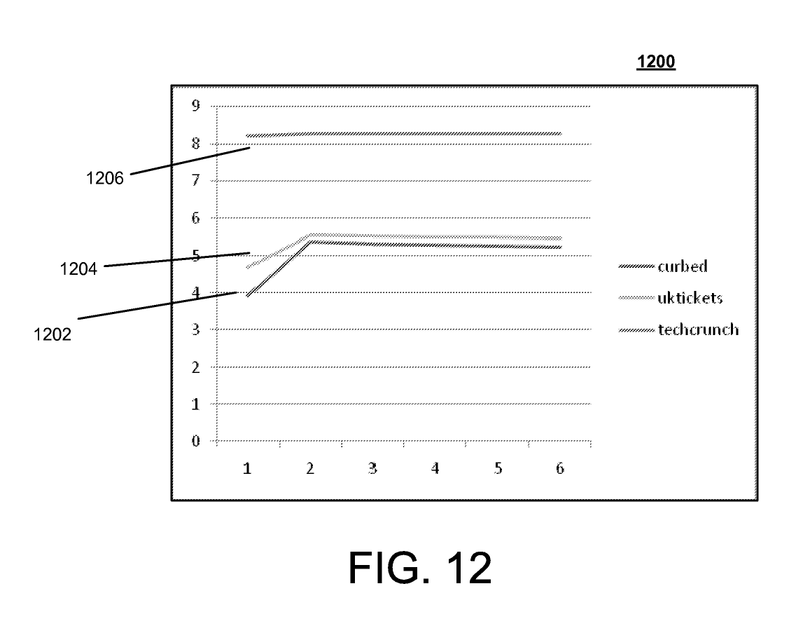

FIG. 12 depicts an example result of entropy/information gain/loss determinations. As shown in FIG. 12, two local blogs 1202, 1204 first indicate an aggregate of nearby locations as the primary audience for the blog content and then start losing entropy. These localities may thus indicate a primary target scope of the blogs 1202, 1204. As shown in FIG. 12, a third non-local blog 1206 (e.g., techcrunch) does not exhibit this characteristic in the example result.

According to an example embodiment, a heuristic based technique may be used to rank the blogs based on the attention data. According to an example embodiment, the results of the clustering component may be used. According to an example embodiment, for each blog, the clusters generated may be ordered by their size. A large difference between the proportion of users associated with the first largest and the second largest clusters may indicate a location bias in the attention data. According to an example embodiment, the blogs may be ranked by this difference as a heuristic for identifying blogs that are potentially hyperlocal in nature.

Example techniques discussed herein may thus provide sets of web page documents (e.g., based on URLs as indicators) that are associated with hyperlocal content. Example techniques discussed herein may further provide hyperlocal content such that users may interact with the extracted data via a user interface (UI) that is text based, or via a mapping interface by which the user may explore a specific neighborhood or a map location and obtain blog posts that discuss specific hyperlocal information (e.g., businesses, streets, neighborhoods) that may be described in the map.

Example techniques discussed herein may further be used to identify blogs that are relevant to a specific map location and may be used in ranking blogs or other web documents.

Customer privacy and confidentiality have been ongoing considerations in online environments for many years. Thus, example techniques for determining hyperlocal content may use aggregate data with regard to visits made to web page documents by users, and may thus avoid accessing data that may be personal to particular visiting users. Further, users may be provided with many different types of opportunities to opt out of allowing their location information to be used for statistical purposes, including specific user permissions that may be requested before collection of the information. For example, a user may be specifically requested to agree to allow their location information to be obtained, before the information is collected. According to an example embodiment herein, personally identifiable information from a user may not be stored in the example system 100.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine usable or machine readable storage device (e.g., a magnetic or digital medium such as a Universal Serial Bus (USB) storage device, a tape, hard disk drive, compact disk, digital video disk (DVD), etc.) or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand alone program or as a module, component, subroutine, or other unit suitable for use in a computing environment. A computer program that might implement the techniques discussed above may be deployed to be executed on one computer or on multiple computers at one site or distributed across multiple sites and interconnected by a communication network.

Method steps may be performed by one or more programmable processors executing a computer program to perform functions by operating on input data and generating output. The one or more programmable processors may execute instructions in parallel, and/or may be arranged in a distributed configuration for distributed processing. Method steps also may be performed by, and an apparatus may be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto optical disks, or optical disks. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back end component, e.g., as a data server, or that includes a middleware component, e.g., an application server, or that includes a front end component, e.g., a client computer having a graphical user interface or a Web browser through which a user can interact with an implementation, or any combination of such back end, middleware, or front end components. Components may be interconnected by any form or medium of digital data communication, e.g., a communication network. Examples of communication networks include a local area network (LAN) and a wide area network (WAN), e.g., the Internet.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A system comprising:
a reference acquisition component that obtains a first indicator associated with a first web page document;
a classification type component that determines a classification type of the first web page document, based on the first indicator and a first content of the first web page document;
an attention geography component that determines a group of first attention geography items associated with the first web page document;
a content geography component that determines a group of first content geography items associated with the first web page document; and
a hyperlocal classifier that determines, via a device processor, whether the first web page document includes a first hyperlocal content page document, based on the group of the first attention geography items and the group of the first content geography items.

2. The system of claim 1, wherein:
the first indicator associated with the first web page document includes a first Uniform Resource Locator (URL) associated with the first web page document, and
the classification type includes one or more of a blog web page type, a sports web page type, a local news web page type, or an event web page type.

3. The system of claim 1, wherein the attention geography component includes:
a visitor determination component that determines a plurality of second indicators, each second indicator associated with a device that is associated with a web visit of the first web page document;
a reverse geocoding component that determines a plurality of first visitor geographic locations, each of the first visitor geographic locations associated with one of the second indicators; and
a geographic cluster component that determines a plurality of clusters of the first visitor geographic locations, based on distances between the first visitor geographic locations.

4. The system of claim 3, wherein:
the visitor determination component determines the plurality of second indicators, each second indicator including one or more of an Internet Protocol (IP) address, Global Positioning System (GPS) coordinate information, or browser log information that is associated with a device that is associated with a web visit of the first web page document, and
the reverse geocoding component determines the plurality of first visitor geographic locations, each of the first visitor geographic locations based on one or more of:
latitude and longitude values associated with one of the second indicators,
visitor device location information associated with one of the second indicators,
IP address information associated with one of the second indicators, or
GPS coordinate information associated with one of the second indicators.

5. The system of claim 3, wherein:
the geographic cluster component determines the plurality of clusters of the first visitor geographic locations, based on distances between the first visitor geographic locations, based on one or more of a k-means clustering algorithm or an agglomerative clustering algorithm.

6. The system of claim 1, further comprising:
a posting crawler component that obtains a plurality of first posted items associated with the first web page document, based on initiating a plurality of first web page retrieval visits to the first web page document; and
a posting locale determination component that determines a first locale associated with the plurality of first posted items based on geographic attributes associated with the obtained plurality of first posted items associated with the first web page document.

7. The system of claim 6, further comprising:
a document transformation component that updates a first annotated document item associated with the first web page document via annotations based on the obtained plurality of first posted items associated with the first web page document.

8. The system of claim 7, further comprising:
an ngram component that obtains tokens based on text included in the plurality of first posted items associated with the first web page document, and determines ranking values of obtained tokens based on term frequency values and document frequency values.

9. The system of claim 1, wherein:
the reference acquisition component obtains a plurality of third indicators associated with a plurality of respective second web page documents, and
the system further includes:
a ranking component that ranks the first web page document and second web page documents based on visitation patterns associated with each of the first web page document and second web page documents.

10. The system of claim 9, wherein:
the ranking component ranks the first web page document and second web page documents based on visitation patterns associated with each of the first web page document and second web page documents, based on one or more of:
a curve fitting function,
a determination of entropy and information gain, or
a heuristic algorithm based on clusters determined by the attention geography component.

11. A method comprising:
obtaining a first indicator associated with a first web page document;
determining a plurality of second indicators, each second indicator associated with a device that is associated with a web visit of the first web page document;
determining a plurality of first visitor geographic locations, each of the first visitor geographic locations associated with one of the second indicators, based on reverse geocoding the plurality of second indicators;
determining, via a device processor, a plurality of clusters of the first visitor geographic locations, based on distances between the first visitor geographic locations; and
determining a geographic locale focus associated with the first web page document, based on the plurality of clusters of the first visitor geographic locations.

12. The method of claim 11, wherein:
determining the plurality of first visitor geographic locations includes determining the plurality of first visitor geographic locations, each of the first visitor geographic locations associated with one of the second indicators, based on reverse geocoding the plurality of second indicators, based on one or more of:
latitude and longitude values associated with one of the second indicators,
visitor device location information associated with one of the second indicators,
IP address information associated with one of the second indicators, or
GPS coordinate information associated with one of the second indicators.

13. The method of claim 11, wherein:
determining the plurality of clusters of the first visitor geographic locations includes determining, via the device processor, the plurality of clusters of the first visitor geographic locations, based on distances between the first visitor geographic locations, based on one or more of a k-means clustering algorithm or an agglomerative clustering algorithm.

14. The method of claim 13, wherein:
determining the plurality of clusters of the first visitor geographic locations includes determining, via the device processor, the plurality of clusters of the first visitor geographic locations, based on distances between the first visitor geographic locations, based on a hierarchical agglomerative clustering algorithm, based on iterative merging of closest pairs of the clusters of the first visitor geographic locations based on geographic distances between pairs of the clusters at each iteration.

15. The method of claim 14, further comprising:
updating a cluster mean value associated with each merged cluster resulting from the iterative merging at the each iteration, based on determining a centroid value based on latitude and longitude values associated with each first visitor geographic location included in the each merged cluster.

16. The method of claim 14, further comprising:
determining a convergence threshold condition for terminating the iterative merging of the closest pairs of the clusters;
when the iterative merging of the closest pairs of the clusters is terminated,
determining a size value for each merged cluster associated with the most recent iteration,
determining a difference in the size values for a first largest and second largest of the merged clusters associated with the most recent iteration, and
determining a location bias value associated with the first web page document based on the determined difference in the size values for the first largest and second largest of the merged clusters associated with the most recent iteration.

17. The method of claim 11, wherein:
determining the plurality of clusters of the first visitor geographic locations includes determining, via the device processor, a plurality of clusters of the first visitor geographic locations, based on distances between the first visitor geographic locations, based on:
determining a first group of initial clusters as the plurality of first visitor geographic locations,
determining a second group of second clusters based on:
determining distances between each of the initial clusters, and
obtaining the second clusters based on merging initial clusters that are closer together pairwise than to other ones of the initial clusters, based on the determined distances between each of the initial clusters; and
determining a third group of third clusters based on:
determining distances between each of the second clusters, and
obtaining the third clusters based on merging second clusters that are closer together pairwise than to other ones of the second clusters, based on the determined distances between each of the second clusters.

18. A computer program product tangibly embodied on a computer-readable storage medium and including executable code that causes at least one data processing apparatus to:
obtain a plurality of first indicators, each first indicator associated with a respective one of a plurality of first web page documents;
determine a classification type of each of the first web page documents, based on the respective first indicators and a respective first content of each of the first web page documents;
select a set of candidate documents that are included in the plurality of first web page documents, based on the determined classification type; and
for each one of the candidate documents,
determine a group of first attention geography items associated with the each one of the candidate documents;
determine a group of first content geography items associated with the each one of the candidate documents; and
determine whether the each one of the candidate documents includes a first hyperlocal content page document, based on the group of the first attention geography items and the group of the first content geography items that are associated with the each one of the candidate documents.

19. The computer program product of claim 18, wherein the executable code is configured to cause the at least one data processing apparatus to:
determine a ranking of the set of candidate documents based on visitation patterns associated with each of the candidate documents, based on one or more of:
a curve fitting function,
a determination of entropy and information gain, or
a heuristic algorithm based on clusters that are based on the determined attention geography items.

20. The computer program product of claim 19, wherein the executable code is configured to cause the at least one data processing apparatus to:
determine whether the each one of the candidate documents includes a first hyperlocal content page document, based on the group of the first attention geography items and the group of the first content geography items that are associated with the each one of the candidate documents, based on the determined ranking.
